(19) United States
(12) Patent Application Publication
(10) Pub. No.: US 2025/0388158 A1
(43) Pub. Date: Dec. 25, 2025

(54) FOLDABLE SEAT DIVIDER

(71) Applicant: Evan C. McWhirter, Louisville, KY (US)

(72) Inventor: Evan C. McWhirter, Louisville, KY (US)

(21) Appl. No.: 18/752,235

(22) Filed: Jun. 24, 2024

(51) Int. Cl. B60N 2/90

(52) U.S. Cl. CPC B60N 2/90

(57) ABSTRACT

A foldable seat divider including one or more sidewalls. One or more of the sidewalls can include a wiring sleeve that can circumscribe the sidewall with a flexible wire inserted into the wiring sleeve. One or more of the sidewalls can include at least one strap. The at least one strap can include an adjustable buckle and/or a clip.

### BACKGROUND

Use of the rear seat of an automobile with small children frequently results in issues related to space, toys and typical young sibling scenarios. It may be preferable to provide a readily available seat divider that is easily portable and collapsable but which can be safely installed to adequately divide the rear seat where small children are situated.

### SUMMARY

Implementations disclosed herein depict a foldable seat divider. In some implementations, a user can deploy the foldable seat divider to partition different areas of an automobile. The foldable seat divider can initially be in a folded position. When the foldable seat divider is in the folded position, it can be easily stored and transported while taking up minimal space. The foldable seat divider can be transitioned into the unfolded position and placed in a particular location in an automobile to create a barrier between two areas of the automobile. The user can secure the foldable seat divider to the automobile seats or to other locations in the automobile. When the user is finished using the foldable seat divider, it can be transitioned into the folded position and stored for the next use.

The foldable seat divider can include one or more sidewalls. For example, the foldable seat divider can include any combination of a first sidewall, and second sidewall, and/or a third sidewall. One or more of the sidewalls may include a wiring sleeve that circumscribes the respective sidewall. For example, the first sidewall can include a first wiring sleeve that circumscribes the first sidewall. Similarly, the second sidewall can include a second wiring sleeve that circumscribes the second sidewall. One or more of the wiring sleeves may have a wire inserted into the wiring sleeve. The wire can be a flexible wire. For example, the first wiring sleeve may have a first flexible wire inserted into it, while the second wiring sleeve can have a second flexible wire inserted into it.

The foldable seat divider can be formed by attaching one or more portions of the sidewalls to one another. For example, a first portion of the first sidewall can be attached to a first portion of the second sidewall. A second portion of the first sidewall can be connected to a first portion of the third sidewall and a second portion of the second sidewall can be connected to a second portion of the third sidewall. Each of the sidewalls can be the same shape and/or different combinations of shapes. For example, both the first sidewall and the second sidewall can be similar shapes, while the third sidewall is a different shape.

There may be one or more portions of each of the sidewalls that are not attached to one or more portions of the other sidewalls. This can form an aperture in the foldable seat divider. For example, there may be a portion of the first sidewall that is not joined to either the second sidewall or the third sidewall. Similarly, there may be a portion of the second sidewall that is not attached to the first sidewall or the third sidewall. There may also be a portion of the third sidewall that is not attached to either the first sidewall or the second sidewall. When these unattached portions of the sidewalls are in adjoining locations, the aperture can be formed.

One or more of the sidewalls can include one or more straps attached to the respective sidewall. For example, the first sidewall can have a first strap, the second sidewall can have a second strap, and the third sidewall can have a third strap and a fourth strap. In some implementations, the first sidewall and/or the second sidewall can each include more than one strap.

The straps can be used to secure the foldable seat divider to the car. For example, the straps can be attached to a car seat via a car seat anchor, a headrest, a seat buckle, and/or any other attachment mechanism within the car. One or more of the straps can also include a clip, such as a snap hook clip. The clip can be used to secure the straps and the foldable seat divider to the car.

One or more of the straps can include a buckle. The buckle can be an adjustable buckle that is used to adjust the length of the straps. The buckle can join a first potion of the straps to a second portion of the straps.

### BRIEF DESCRIPTION OF THE DRAWINGS

FIG. 1 depicts a perspective view of a foldable seat divider.

FIG. 2A depicts a side perspective view of a first sidewall of a foldable seat divider.

FIG. 2B depicts a side perspective view of a second sidewall of a foldable seat divider.

FIG. 3A depicts a top perspective view of a third sidewall of a foldable seat divider.

FIG. 3B depicts a bottom perspective view of a third sidewall of a foldable seat divider.

FIG. 3C depicts a side perspective view of a third sidewall of a foldable seat divider.

FIG. 4A depicts a foldable seat divider while in a folded position.

FIG. 4B depicts a foldable seat divider between a folded position and an unfolded position.

FIG. 4C depicts a foldable seat divider in an unfolded position.

### DETAILED DESCRIPTION

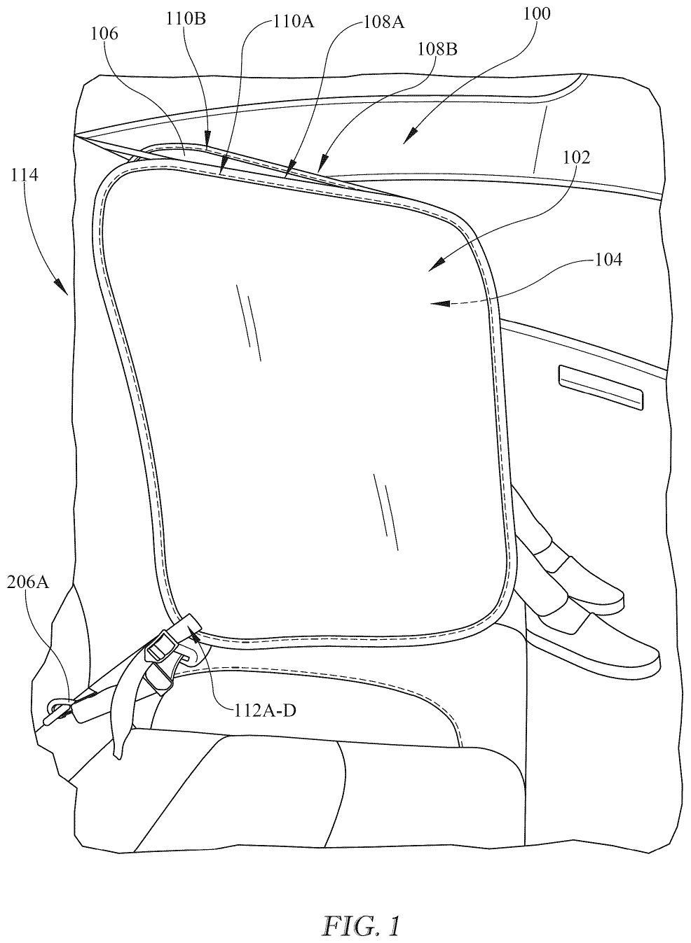

Turning now to FIG. 1, an example environment that demonstrates various aspects of the present disclosure, and in which implementations disclosed herein can be implemented is depicted. A perspective view of a foldable seat divider 100 is depicted. The foldable seat divider 100 can include a first sidewall 102, a second sidewall 104, and a third sidewall 106. The first sidewall 102 and the second sidewall 104 can include wire sleeves 108A-B. Each of the wire sleeves 108A-B can circumscribe the first sidewall 102 and/or the second sidewall 104. A wire 110A-B can be inserted into a respective wire sleeve 108A-B. The first sidewall 102 and the second sidewall 104. can be attached to one another. For example, one edge of the first sidewall 102 can be attached to a similar edge of the second sidewall 104. The third sidewall 104 can be attached to both the first sidewall 102 and the second sidewall 104. A plurality of straps 112A-D can be attached to the foldable seat divider 100. One or more of the plurality of straps 112A-D can be attached to one or more portions of a car 114. For example, one or more of the straps 112A-D can be attached to a car seat anchor of the car 114. The foldable seat divider 100 can be positioned in the seat of the car, in the floor space, in the trunk, or in any other suitable location inside the car.

In some implementations, the foldable seat divider 100 can include various combinations of the first sidewall 102, the second sidewall 104, and the third sidewall 106. For example, the foldable seat divider 100 may only include the first sidewall 102 or a combination of the first sidewall 102 and the second sidewall 104.

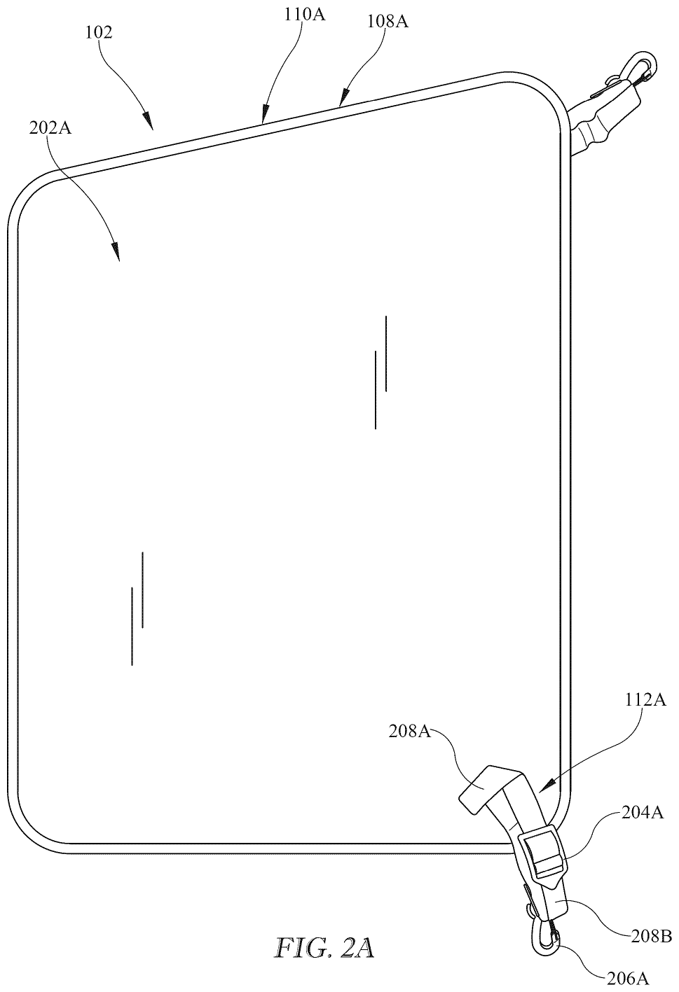

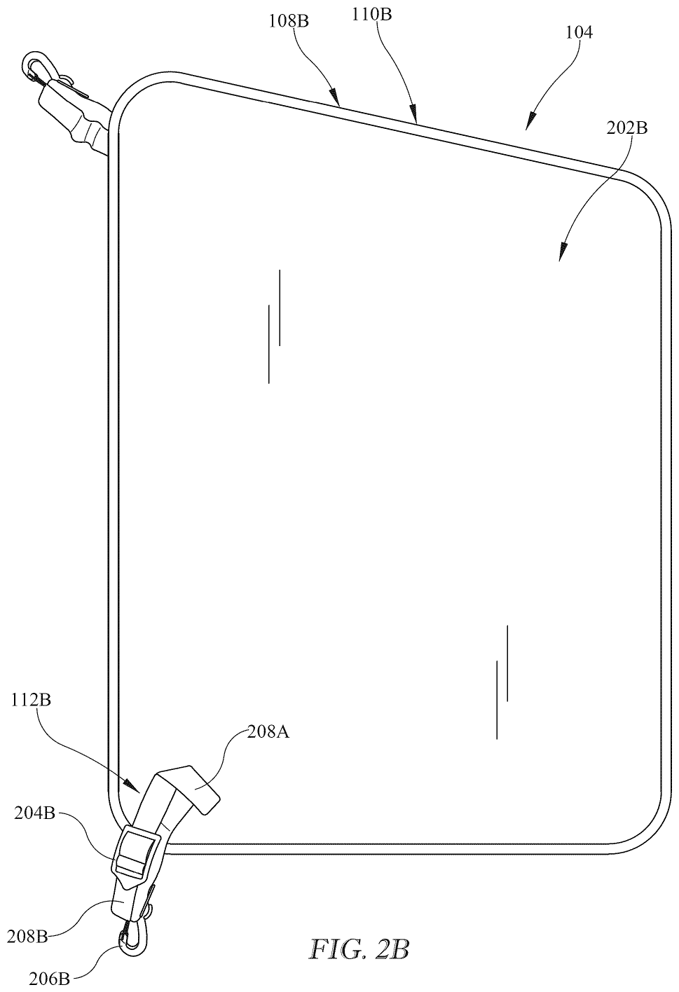

FIGS. 2A-2B depict side perspectives of each of the first sidewall 102 and the second sidewall 104 of the foldable seat divider 100. The first sidewall 102 and the second sidewall 104 each include a respective sidewall face 202A-B and a respective wire sleeve 108A-B. Each of the wire sleeves 108A-B can circumscribe a respective one of the sidewall faces 202A-B. For example, the wire sleeves 108A-B can be sewn around the outer edge of the respective sidewall face 202A-B. A respective wire 110A-B can be inserted into a respective one of the wire sleeves 108A-B.

The wires 110A-B, when inserted into the respective wire sleeves 108A-B, can give the first sidewall 102 and the second sidewall 104 form. For example, the sidewall faces 202A-B can be made of a cloth or fabric material. The wire sleeves 108A-B can also be made of a cloth or fabric material. The material the sidewall faces 202A-B and the wire sleeves 108A-B are made of may not have the structural integrity to support itself standing on its own. The wires 110A-B, when inserted into the wire sleeves 108A-B can stretch each of the sidewall faces 202A-B taut. The first sidewall 102 and the second sidewall 104 can each be generally rectangular in shape. Alternatively, each of the first sidewall 102 and the second sidewall 104 can be different shapes, such as circles, triangles, or any other shape or combination of shapes.

The first sidewall 102 and the second sidewall 104 can each include a respective strap 112A-B. Each of the straps 112A-B can be positioned at a similar location on each respective one of the first sidewall 102 and the second sidewall 104. For example, each of the respective straps can be attached to a respective sidewall face 202A-B, or a respective wire sleeves 108A-B. The straps 112A-B can each be positioned at a respective corner or side of the first sidewall 102 and the second sidewall 104. For example, each of the straps 112A-B can be positioned in a bottom corner of the first sidewall 102 and the second sidewall 104. In some implementations, each of the first sidewall 102 and the second sidewall 104 can include multiple straps 112A-B. Alternatively, one or both of the first sidewall 102 and the second sidewall 104 may not include a strap 112A-B.

The straps 112A-B can each include a buckle 204A-B. The buckles 204A-B can be used to adjust the length of the straps 112A-B. The straps 112A-B can include a first strap portion 208A and a second strap portion 208B. The first strap portion 208A can be joined to the second strap portion 208B by one of the buckles 204A-B. The first strap portion 208A can be joined to one of the first sidewall 102 and/or the second sidewall 104.

The straps 112A-B can also and/or alternatively include clips 206A-B. The clips 206A-B may be attached to the second strap portion 208B. The clips 206A-B can attach to the car. For example, the clips 206A-B can be a snap hook clip that attaches to the car seat anchors in the seat of the car or a side release buckle configuration. Alternatively, the clips 206A-B can be configured to be secured to the seatbelt mechanism of the car seat or to a headrest of a car seat. A user can secure the clips 206A-B to the car and then adjust the length of the straps 112A-B using the buckle 204A-B.

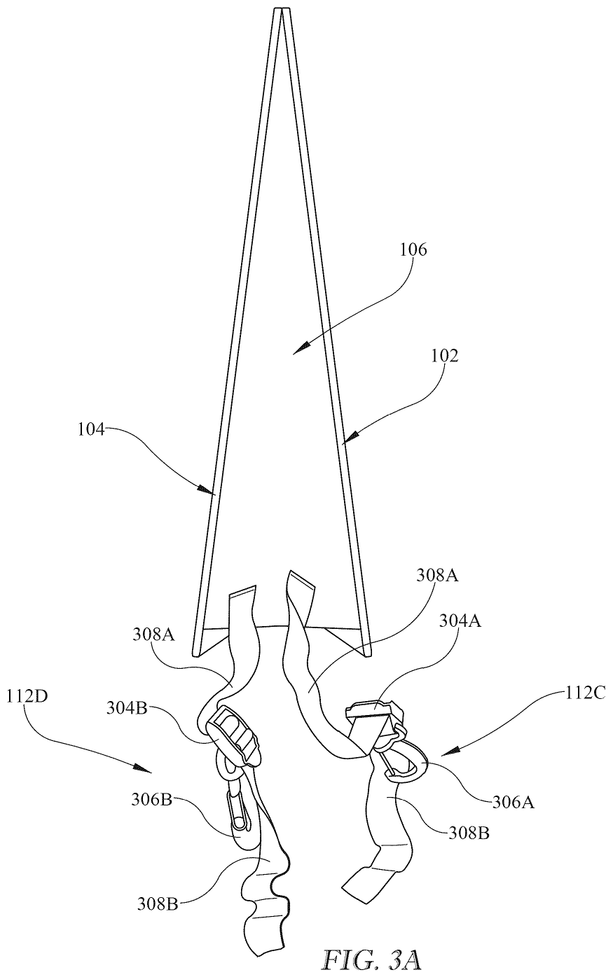

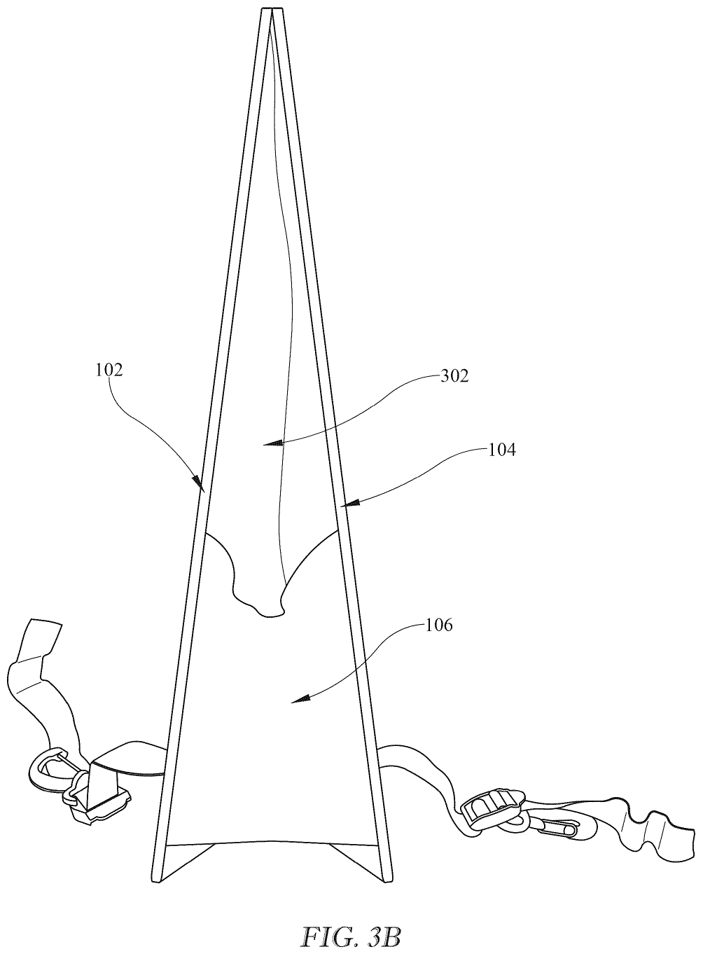

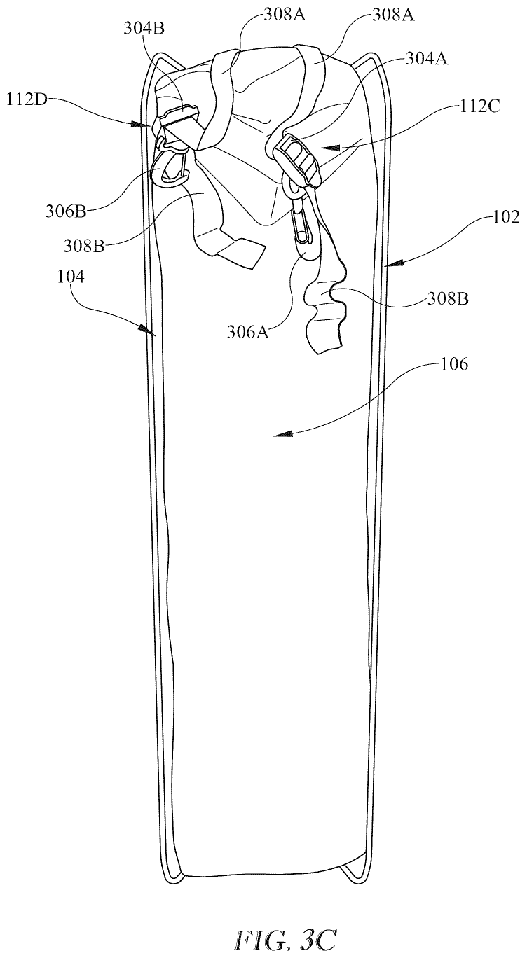

Turning now to FIGS. 3A-3C, a top, bottom, and side perspective of the third sidewall 106. The third sidewall 106 can be attached to a portion of the first sidewall 102 and a portion of the second sidewall 104. For example, the first sidewall 102 and the second sidewall 104 can be attached along a particular edge of both the first sidewall 102 and the second sidewall 104. The third sidewall 106 can be connected to the first sidewall 102 along an outer portion that is not connected to the second sidewall 104 and the third sidewall 106 can be connected to the second sidewall 104 along an outer portion that is not connected to the first sidewall 102. In some implementations, the third sidewall 106 includes a wire sleeve and/or a flexible wire, however, in alternate implementations, the third sidewall 106 may not include a wire sleeve and/or a flexible wire.

An aperture 302 can be positioned in a space between the first sidewall 102, the second sidewall 104, and the third sidewall 106 when a portion of the first sidewall 102 that is not connected to the second sidewall 104 or third sidewall 106 meets a portion of the second sidewall 102 that is not connected to the first sidewall 102 or the third sidewall 106 and a portion of the third sidewall 106 that is not attached to either the first sidewall 102 or the second sidewall 104. The aperture 302 can allow a user to access the interior of the foldable seat divider 100 that is formed by the attached portions of the first sidewall 102, the second sidewall 104, and the third sidewall 106.

The third sidewall can include one or more straps 112C-D. Similar to the straps 112A-B described with respect to FIGS. 2A-2B, straps 112C-D can each include a first strap portion 308A and a second strap portion 308B. The first strap portion 308A can be joined to the second strap portion 308B by a buckle 304A-B. The buckles 304A-B can be used to adjust the length of the straps 112C-D. The first strap portion 308a can be attached to the third sidewall 106.

The straps 112C-D can also and/or alternatively include clips 306A-B. The clips 306A-B may be attached to the second strap portion 308B. The clips 306A-B can attach to the car. For example, the clips 306A-B can be a snap hook clip that attaches to the car seat anchors in the seat of the car or a side release buckle configuration. Alternatively, the clips 306A-B can be configured to be secured to the headrest of a car seat or to be received within the seatbelt mechanism. A user can secure the clips 306A-B to the car and then adjust the length of the straps 112C-D using the buckle 304A-B.

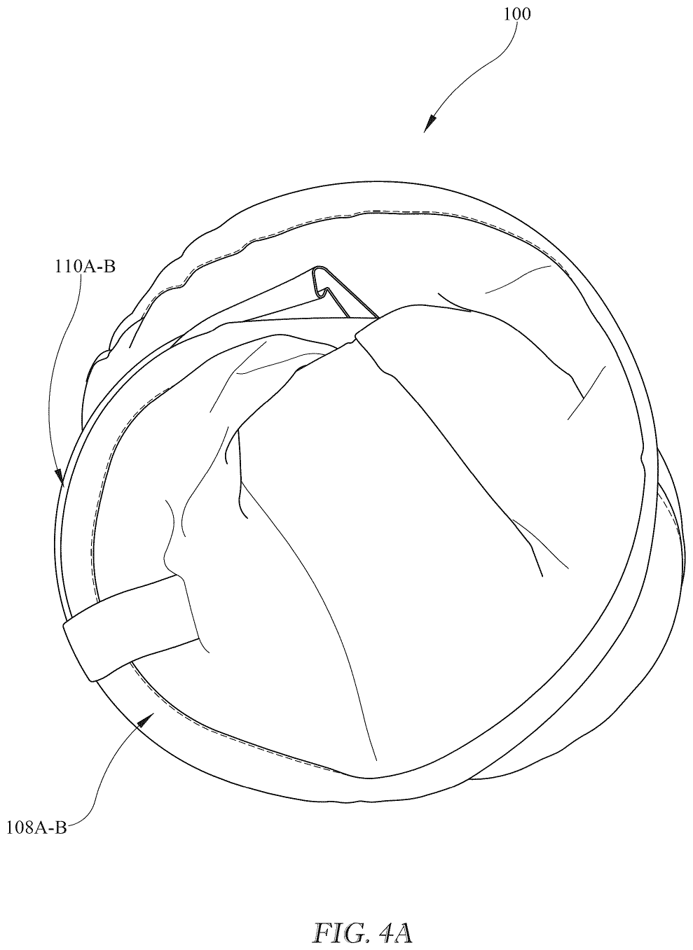

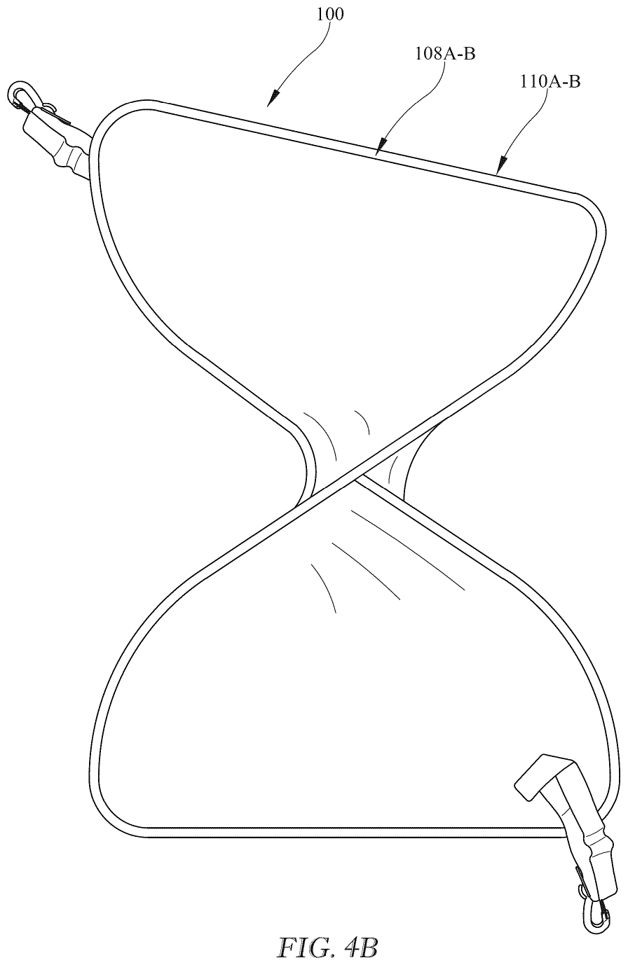

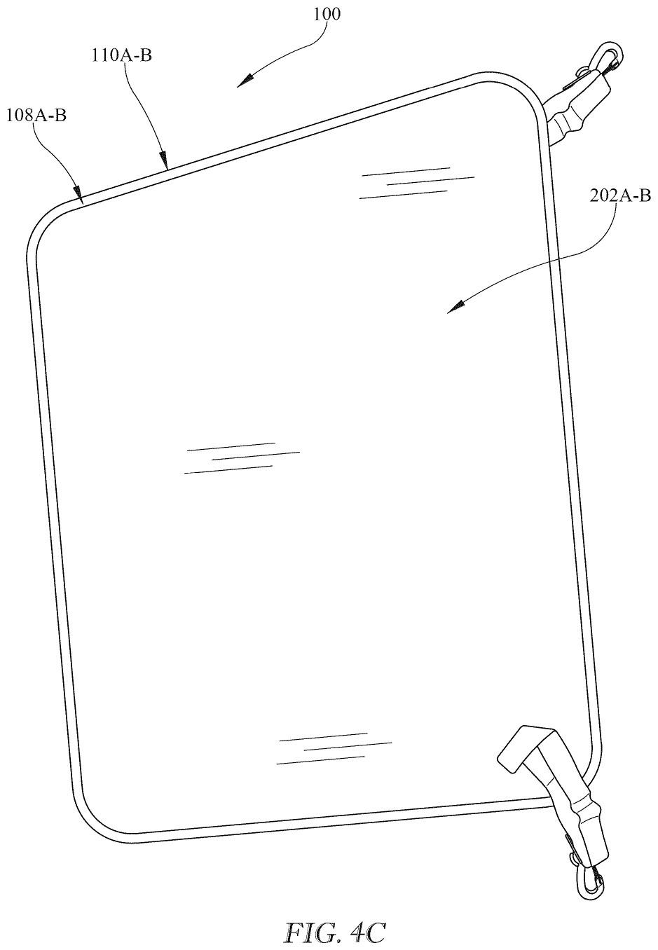

Turning now to FIGS. 4A-C, a foldable seat divider 100 in the folded position, between the folded and unfolded positions, and in the unfolded position is depicted. The wires 110A-B that are inserted into the wire sleeves 108A-B can be flexible. A user can apply pressure and torque to the wires 110A-B such that the wires 110A-B twist and fold on top of themselves. The result can be as depicted in FIG. 4A, where the foldable seat divider 100 is in a folded position. The foldable seat divider 100 can be stored in a variety of locations when in the folded position. For example, a user can manipulate the foldable seat divider 100 into the folded position, and then place the foldable seat divider 100 into a seat back pocket.

To transition the foldable seat divider 100 from the folded position to the unfolded position, a user can manipulate the wires 110A-B such that the foldable seat divider 100 and the wires 110A-B untwist and unfold, as depicted in FIG. 4B. When the foldable seat divider 100 is in the unfolded position, as depicted in FIG. 4-B, the wires 110A-B can be untwisted and can stretch taut each of the sidewall faces 202A-B. The foldable seat divider 100 can stand on its own when in the unfolded position.

What is claimed is:

1. A foldable seat divider comprising:
a first sidewall, a second sidewall, and a third sidewall, wherein the first sidewall has a first wiring sleeve circumscribing an outer portion of the first sidewall and the second sidewall has a second wiring sleeve circumscribing an outer portion of the second sidewall, and wherein at least a first portion of the first sidewall is attached to at least a first portion of the second sidewall and a second portion of the first sidewall is attached to a first potion of the third sidewall, and a second portion of the second sidewall is attached to a second portion of the third sidewall;
a first flexible wire inserted into the first wiring sleeve;
a second flexible wire interested into the second wiring sleeve;
a first strap attached to the first sidewall;
a second strap attached to the second sidewall; and
a third strap and a fourth strap attached to the third sidewall.

2. The foldable seat divider of claim 1, wherein one or more of the first strap, second strap, third strap, and fourth strap include an adjustable buckle.

3. The foldable seat divider of claim 2, wherein one or more of the first strap, second strap, third strap, and fourth strap include a first strap portion and a second strap portion, wherein the first strap portion is joined to the second strap portion with the adjustable buckle.

4. The foldable seat divider of claim 1, wherein one or more of the first strap, second strap, third strap, and fourth strap include a clip.

5. The foldable seat divider of claim 4, wherein the clip of one or more of the first strap, second strap, third strap, and fourth strap is a snap hook clip.

6. The foldable seat divider of claim 1, further comprising:
an aperture in the foldable seat divider, the aperture comprising a gap in between the first sidewall, the second sidewall, and the third sidewall.

7. The foldable seat divider of claim 1, wherein the first sidewall and the second sidewall are the same shape.

8. A foldable seat divider comprising:
a first sidewall and a second sidewall, wherein the first sidewall has a first wiring sleeve circumscribing an outer portion of the first sidewall and the second sidewall has a second wiring sleeve circumscribing an outer portion of the second sidewall, and wherein at least a first portion of the first sidewall is attached to at least a first portion of the second sidewall;
a first flexible wire inserted into the first wiring sleeve;
a second flexible wire interested into the second wiring sleeve; and
one or more straps attached to one or both of:
the first sidewall; and
the second sidewall.

9. The foldable seat divider of claim 8, wherein one or more of the straps include an adjustable buckle.

10. The foldable seat divider of claim 9, wherein one or more of the straps include a first strap portion and a second strap portion, wherein the first strap portion is joined to the second strap portion by the adjustable buckle.

11. The foldable seat divider of claim 8, wherein one or more of the straps include a clip.

12. The foldable seat divider of claim 11, wherein one or more of the clips is a snap hook clip.

13. The foldable seat divider of claim 8, wherein the one or more straps include a first pair of straps attached to the first sidewall.

14. The foldable seat divider of claim 13, wherein the one or more straps further include a second pair of straps attached to the second sidewall.

15. A foldable seat divider comprising:
one or more sidewalls, wherein one or more of the sidewalls include a wiring sleeve circumscribing an outer portion of one or more of the sidewalls;
a flexible wire inserted into each of the wiring sleeves; and
one or more straps attached to one or more of the sidewalls.

16. The foldable seat divider of claim 15, wherein one or more of the straps include an adjustable buckle.

17. The foldable seat divider of claim 16, wherein one or more of the straps include a first strap portion and a second strap portion, wherein the first strap portion is joined to the second strap portion by the adjustable buckle.

18. The foldable seat divider of claim 15, wherein one or more of the straps include a clip.

19. The foldable seat divider of claim 18, wherein one of more of the clips is a snap hook clip.

20. The foldable seat divider of claim 15, wherein the one or more straps include a pair of straps attached to one or more of the sidewalls.
